(19) United States
(12) Patent Application Publication
(10) Pub. No.: US 2024/0222609 A1
(43) Pub. Date: Jul. 4, 2024

(54) VOPO4 CATHODE FOR SODIUM ION BATTERIES

(71) Applicant: The Research Foundation for The State University of New York, Binghamton, NY (US)

(72) Inventors: M. Stanley Whittingham, Vestal, NY (US); Jia Ding, Binghamton, NY (US)

(21) Appl. No.: 18/432,831

(22) Filed: Feb. 5, 2024

Related U.S. Application Data
(62) Division of application No. 17/705,780, filed on Mar. 28, 2022, now Pat. No. 11,894,550.
Application No. 17/705,780 is a division of application No. 15/633,240, filed on Jun. 26, 2017, now Pat. No. 11,289,700.
(60) Provisional application No. 62/355,639, filed on Jun. 28, 2016.

(51) Int. Cl. H01M 4/38; C01G 31/00; C08F 14/18; C08K 3/04; C08K 3/32; C08L 9/08; C09D 127/06; C09D 127/16; H01M 4/02; H01M 4/58; H01M 4/62; H01M 10/054

(52) U.S. Cl. CPC H01M 4/381; C01G 31/006; C08K 3/04; C08K 3/32; C09D 127/06; C09D 127/16; H01M 4/5825; H01M 4/622; H01M 4/623; H01M 4/625; H01M 10/054; C01P 2002/72; C08F 14/18; C08K 2003/328; C08L 9/08; H01M 2004/028

(57) ABSTRACT

An electrode comprising a space group Pna2₁ VOPO₄ lattice, capable of electrochemical insertion and release of alkali metal ions, e.g., sodium ions. The VOPO₄ lattice may be formed by solid phase synthesis of KVOPO₄, milled with carbon particles to increase conductivity. A method of forming an electrode is provided, comprising milling a mixture of ammonium metavanadate, ammonium phosphate monobasic, and potassium carbonate; heating the milled mixture to a reaction temperature, and holding the reaction temperature until a solid phase synthesis of KVOPO₄ occurs; milling the KVOPO₄ together with conductive particles to form a conductive mixture of fine particles; and adding binder material to form a conductive cathode. A sodium ion battery is provided having a conductive NaVOPO₄ cathode derived by replacement of potassium in KVOPO₄, a sodium ion donor anode, and a sodium ion transport electrolyte. The VOPO₄, preferably has a volume greater than 90 Å³ per VOPO₄.

### CROSS REFERENCE TO RELATED APPLICATIONS

The present application is Divisional of U.S. patent application Ser. No. 17/705,780, filed Mar. 28, 2022, now U.S. Pat. No. 11,894,550, issued Feb. 6, 2024, which is a Divisional of U.S. patent application Ser. No. 15/633,240, filed Jun. 26, 2017, now U.S. Pat. No. 11,289,700, issued Mar. 29, 2022, which is a non-provisional of and claims benefit of priority under 35 U.S.C. § 119(e), from U.S. Provisional Patent Application No. 62/355,639, filed Jun. 28, 2016, each of which are expressly incorporated herein by reference in its entirety.

### STATEMENT OF GOVERNMENT RIGHTS

This invention was made with government support under DE-SC0012583 awarded by the Department of Energy. The government has certain rights in the invention.

### FIELD OF THE INVENTION

The present invention relates to the field of electrode materials for batteries, and more particularly to a vanadyl phosphate cathode for a sodium ion battery.

### BACKGROUND OF THE INVENTION

Energy conversion and storage have become more and more important in transportation, commercial, industrial, residential, and consumer applications. In particular, large-scale implementation of renewable energy, increasing ubiquity of portable electronics, and the next generation of electric vehicles require inexpensive and efficient energy storage systems.

In the past several decades, the advanced electrical energy storage systems were primarily based on lithium ion battery technologies. However, there is a rapidly increasing concern for the scalability of lithium ion-based system (e.g., electric vehicles, electric grids, stationary applications) due to the limited abundance and high cost of lithium. Sodium is an attractive alternative to lithium due to the greatly lower cost and wider global abundance of sodium (e.g., $150 vs. $3,000 per ton, metal price). Therefore, sodium ion batteries have attracted increasing attention from both academia and industry.

In order to practically operate the sodium-based system, there is a huge demand of suitable electrode materials, especially on the cathode side. Due to the much larger size of Na⁺(1.02 Å) than Li⁺(0.76 Å), successful intercalation host materials should possess channels and interstitial sites compatible with the larger size of the sodium cation. The capacity of a sodium ion anode material is lower than a lithium ion anode material. Moreover, for the full device, the lower operating voltage (i.e., −2.7 V for Na/Na⁺ vs. SHE) can make the energy of sodium-based devices even lower.

Therefore, it is desirable to develop a cathode with high capacity, high working potential and practical cyclability. Various types of sodium ion battery cathode materials have been developed, such as layered oxides (e.g., NaMnO₂), tunnel oxides (e.g., Na_{0.44}MnO₂), olivine (e.g., NaₓFe_{0.5}Mn_{0.5}PO₄), polyphosphates (e.g., Na₂FeP₂O₇), NASICONS (e.g., Na₃V₂(PO₄)₃), and fluorophosphates (e.g., NaVPO₄F), etc. Based on a comparative study of the critical cathode attributes, including capacity, energy density and safety, vanadium-based phosphates cathodes should be the relatively optimized choice. See, Stanislav S. Fedotov, Nellie R. Khasanova, Aleksandr Sh. Samarin, Oleg A. Drozhzhin, Dmitry Batuk, Olesia M. Karakulina, Joke Hadermann, Artem M. Abakumov, and Evgeny V. Antipov; “AVPO₄F (A=Li, K): A 4 V Cathode Material for High-Power Rechargeable Batteries”; Chem. Mater., 2016, 28 (2), pp 411-415 (Jan. 4, 2016), DOI: 10.1021/acs.chemmater.5b04065, expressly incorporated herein by reference in its entirety.

Phosphate based materials have been considered as excellent cathode candidates because of their high stability and low cost. However, most phosphate cathodes show poor electronic conductivity and as a result, full capacity of the cathode can't be achieved in the traditional charge/discharge processes.

One approach to obtain a cathode of high capacity is to employ a transition metal capable of multiple electron transfer, and thus able to assume more than one sodium. Vanadium is well-known to be capable of transfer of two electrons, such as from the +5 to +3 oxidation state.

Vanadyl phosphate (VOPO₄) is a material combining the merits of vanadium and of phosphate and theoretically has the possibility to show high capacity as well as good stability as a cathode active material for a sodium battery. The vanadyl phosphates with formula of AVOPO₄ (A=alkali metal) form a class of materials which can serve as a multi-electron cathode. These cathodes can utilize the V³⁺-V⁴⁺-V⁵⁺ redox couples, during which two ions can be reversible stored in the structure instead of one. Therefore, this class of cathode materials is expected to exhibit much higher energy density than the traditional one-electron cathodes. By far, the two-electron behavior only has been observed in Li ion system (i.e., two-Li) in some different phases of VOPO₄ and LiVOPO₄, within a voltage window covering the V³⁺→V⁵⁺ transition, which exhibits enhanced practical energy densities. However, the two-electron behavior has never been seen for two-Na storage in the vanadyl phosphate cathode materials. In fact, considering the intrinsic low energy density of sodium ion-based systems, the multi-electrode sodium ion cathode would be even more desirable.

For instance, graphite, the commercial anode active material in lithium-ion batteries, cannot accommodate the insertion of Na to a concentration higher than Na_{0.0625}C₆ and is electrochemically irreversible. As a result, graphite is unsuitable as a sodium-ion battery anode. Thus, the fundamental differences between lithium and sodium appear to dictate that it may be impossible to simply adopt the knowledge and the techniques developed for lithium-ion batteries to sodium-ion batteries.

Vanadium phosphate materials have been described as cathode materials.

For example, U.S. Pat. No. 6,872,492 (Barker et al.) describes sodium ion batteries based on cathode materials of the general formula: AₐM_{b}(XY₄)_{c}Z_{d}. Example 4b describes synthesis of VOPO₄xH₂O and Examples 4c and 4d describe synthesis of NaVOPO₄. Charge and discharge of a cell containing a cathode of the NaVOPO₄ and a negative electrode of lithium metal is described. Sodium ion cells prepared are based on a carbon composite negative electrode and NaVOPO₄F as the positive electrode active material.

U.S. 2013/0034780 (Muldoon et al.) describes a magnesium battery and lists VOPO₄ as a suitable positive electrode active material.

U.S. 2004/0048157 (Neudecker et al.) describes a lithium solid state thin film battery containing a lithiated vanadium oxide film as an anode and as one possible cathode material, LiVOPO₄.

U.S. 2013/0260228 (Sano et al.) describes a lithium secondary battery having as a positive electrode material, a compound of the formula: Lia(M)_{b}(PO₄)_{c}F_{d}. LiVOPO₄ is described in a preferred embodiment.

U.S. 2013/0115521 (Doe et al.) describes a magnesium secondary battery wherein the current collectors are coated with a thin protective coating. VOPO₄ is listed as a positive electrode active material.

U.S. 2012/0302697 (Wang et al.) describes a magnesium cell having a carbon or other graphitic material as a cathode active material. VOPO₄ is included in a list of other cathode active materials.

It is an object of this invention to provide safe, efficient and a high-capacity cathode active material for use in a sodium battery.

A prior attempt at an improved cathode material for a sodium ion battery employed ε-VOPO₄ as an active ingredient, wherein the electrode is capable of insertion and release of sodium ions. See, U.S. Ser. No. 14/735,894 filed Jun. 10, 2015, expressly incorporated herein by reference in its entirety. Upon electrochemical cycling, the cathode may contain regions of material of formula Naₓ(ε-VOPO₄) wherein x is a value from 0.1 to 1.0. ε-VOPO₄ is capable of insertion and deinsertion of sodium ions without significant degradation of the structure after the first insertion cycle. The first discharge profile was much different from that of the following cycles.

Seven distinct VOPO₄ structures or phases are known. All of the reported structures contain VO₆ octahedra sharing vertices with PO₄ tetrahedra. The oxygen polyhedron of vanadium is irregular so that it is often considered as a VO₅ square pyramid with a very short apical vanadyl bond (V═O) and a much more remote sixth oxygen atom (V . . . 0). These seven phases can be distinguished as:
α₁: has a lamellar structure with alternating antiparallel V═O bonds pointing inside the layers.
α_{II}: also has a lamellar structure with antiparallel V═O bonds pointing outside the layers.
γ: is an intermediate form between α₁ and α_{II} with half parallel V═O bonds pointing inside, half outside the layers.
δ: has antiparallel V═O bonds pointing half inside, half outside the layers. The vanadyl chains point to different directions in the unit cell.
ω: shows disordered vanadyl chains in the [1 0 0] and [0 1 0] directions of the tetragonal cell.
β: All vanadyl chains are parallel and tilted to form zigzag O=V . . . O=V chains.
ε: The structure is a distorted form of 3-phase and differs in terms of tilted O=V . . . O angle.

Examples of anode materials identified for anode construction of a sodium battery are shown in the following Table. The energy density in Table 1 is calculated with a cathode voltage at 3.4 V.

TABLE 1
Anode materials.

| | Sodiation | | | | Diffusion |
|---|---|---|---|---|---|
| | voltage (V vs. | Capacity | Energy | Volumetric | barrier |
| Anode | Na/Na⁺ | (mAh/g) | density | expansion | (eV) |
| Hard carbon (a) | 0.01 | 300 | 1017 | ~0% | |
| Tin (b) | 0.20 | 845 | 2704 | 318% | |
| Antimony (c) | 0.58 | 659 | 1858 | 285% | |
| Titanate (d) | 0.3 | 300 | 930 | ~10% | 0.25-0.41 |
| BC₃ | 0.44 | 762 | 2256 | ~0% | 0.16-0.28 |
| boron-doped | | | | | |
| graphene (e) | | | | | |

Komaba et al., “Electrochemical Na Insertion and Solid Electrolyte Interphase for Hard-Carbon Electrodes and Application to Na-Ion Batteries,” Adv. Fund. Mater. 21, 3859, 2011.

Zhu et al., “Tin Anode for Sodium-Ion Batteries Using Natural Wood Fiber as a Mechanical Buffer and Electrolyte Reservoir,” Nano Lett., 13, 3093, 2013.

Qian et al., “High capacity of Na-storage and superior cyclability of nanocomposite Sb/C anode for Na-ion batteries,” Chem. Commun. 48, 7070, 2012.

Senguttuvan et al., “Low-Potential Sodium Insertion in a NASICON-Type Structure through the Ti(III)/Ti(II) Redox Couple,” J. Am. Chem. Soc. 135, 3897, 2013; Sun et al., “Direct atomic-scale confirmation of three-phase storage mechanism in Li₄Ti₅O₁₂ Anodes for room temperature sodium-ion batteries,” Nature Communications, 4, 1870, 2013.

A boron-doped graphene sheet is a suitable anode material for rechargeable sodium-ion batteries. (See US 2015/0147642).

The ubiquitous availability of inexpensive sodium and the increasing demand for lithium used in Li-ion batteries has prompted investigation of Na-ion batteries based on chemical strategies similar to those used for rechargeable Li-ion batteries. However, the larger Na⁺ ions are not stable in the interstitial space of a close-packed oxide-ion array strongly bonded in three dimensions (3D). The 2D layered oxides are able to expand the space between MO₂ layers to accommodate the large Na⁺ ions, but Na⁺—Na⁺ coulomb interactions and a preference for Na⁺ to occupy trigonal-prismatic rather than octahedral oxide sites, lead to a sequence of phase transitions with accompanying undesirable voltage steps on removal/insertion of Na⁺ ions.

It was shown over that fast Na⁺ transport in an oxide requires a host framework structure having a more open interstitial space as in the NASICON structure of the Na⁺ electrolyte Na₁₊ₓZr₂(P₁₋ₓSiₓO₄)₃ with x˜2/3. However, open frameworks reduce the volumetric energy density and their activation energy for Na⁺ diffusion limits the rate of insertion/extraction of Na⁺ at lower temperatures, which will probably restrict the use of a Na-ion battery to stationary storage of electrical energy generated from wind and solar energy where lower cost can give a competitive advantage. Since open oxide-framework structures rely on (XO₄)^{m-} polyanions in place of O²⁻ ions, these phases generally have separated redox centers to give a reduced mixed-valence electronic conductivity.

The anode containing any of the above-listed materials may be mixed with other electrically conductive materials and binders. Examples of electrically conductive materials include carbon black and vapor ground carbon fibers. Examples of binders include polyvinylidene fluoride (PVDF), sodium alginate, and sodium carboxymethyl cellulose.

The cathode active material may be mixed with conductive additives and binders recognized by one of skill in the art as suitable for sodium-ion batteries. For example, suitable binders may include PVDF, polytetrafluoroethylene (PTFE), styrene butadiene rubber (SBR), and polyimide. Suitable conductive additives may include carbonaceous materials such as acetylene black.

The cathode active material may be present as a sheet, ribbon, particles, or other physical form. An electrode containing the cathode active material may be supported by a current collector. A current collector may include a metal or other electrically conducting material. The current collector may be formed of carbon, carbon paper, carbon cloth or a metal or noble metal mesh or foil.

Suitable electrolyte salts include, for example, NaPF₆, NaBF₄, NaClO₄, NaTFSI. Suitable solvents may be any solvent which is stable within the electrochemical window of the cell and is inert to other components of the cell. Examples of suitable solvents include carbonate solvents such as ethylene carbonate, diethyl carbonate, and propylene carbonate, organic ethers such as dioxolane, dimethyl ether and tetrahydrofuran and organic nitriles such as acetonitrile. Additionally, the electrolyte may be a nonaqueous polymer electrolyte such as a gel polymer electrolyte, a solid ceramic electrolyte such as sodium β″-alumina solid electrolyte (BASE) ceramic and NASICON (see, U.S. Pub. App. 20140186719) compounds. In one embodiment, the electrolyte may include additives such as fluoroethylene carbonate (FEC) in order to, for example, improve cycling.

The battery may also include a separator which helps maintain electrical isolation between the cathode and the anode. A separator may include fibers, particles, web, porous sheets, or other forms of material configured to reduce the risk of physical contact and/or short circuit between the electrodes. The separator may be a unitary element, or may include a plurality of discrete spacer elements such as particles or fibers. In some examples, the electrolyte layer may include a separator infused with an electrolyte solution. In some examples such as a polymer electrolyte, the separator may be omitted.

See: U.S. Pat. Nos. 8,318,353; 7,901,810; 7,790,319; 7,771,628; 7,759,008; 7,041,239; 6,872,492; 4,355,162; 4,376,709; 4,376,709; 4,459,406; 5,849,434; 6,844,047; 6,872,492; 6,872,492; 6,888,663; 6,958,860; 7,041,239; 7,338,734; 7,383,083; 7,759,008; 7,759,008; 7,771,628; 7,790,319; 7,901,810; 7,939,201; 7,955,733; 7,960,058; 7,964,308; 7,972,728; 7,988,746; 7,998,617; 8,003,250; 8,057,936; 8,067,117; 8,088,512; 8,148,009; 8,148,013; 8,158,090; 8,168,326; 8,206,468; 8,206,469; 8,218,351; 8,241,789; 8,277,975; 8,282,691; 8,318,353; 8,323,831; 8,323,832; 8,361,661; 8,420,258; 8,435,678; 8,445,135; 8,449,980; 8,481,208; 8,492,031; 8,580,430; 8,586,238; 8,617,430; 8,617,745; 8,652,683; 8,658,310; 8,709,647; 8,722,227; 8,722,227; 8,722,242; 8,734,539; 8,785,043; 8,821,763; 8,852,807; 8,932,762; 8,936,871; 8,951,676; 8,951,680; 8,993,171; 8,999,571; 9,065,093; 9,077,032; 9,293,790; 9,299,966; 9,305,716; 9,349,544; 9,362,562; 20020192553; 20020192553; 20020192553; 20040005265; 20040016632; 20040016632; 20040048157; 20040066556; 20040197654; 20040197654; 20040262571; 20040262571; 20050238961; 20050238961; 20050238961; 20060110580; 20060194112; 20060194112; 20060292444; 20070031732; 20070072034; 20070072034; 20070141468; 20070141468; 20070166617; 20070190418; 20070248520; 20070292747; 20070298317; 20080261113; 20080261113; 20090214944; 20090220838; 20090220838; 20090246636; 20090311597; 20100075225; 20100078591; 20100233545; 20100266899; 20100266899; 20100303701; 20110052473; 20110052986; 20110052986; 20110052986; 20110052995; 20110159381; 20110195306; 20110200848; 20110200848; 20110229765; 20110229765; 20110274948; 20120140378; 20120164499; 20120164499; 20120214071; 20120219856; 20120219859; 20120237828; 20120270109; 20120315538; 20130034780; 20130052492; 20130059211; 20130078523; 20130078524; 20130084474; 20130084474; 20130084474; 20130115521; 20130252112; 20130252114; 20130302697; 20130344367; 20130344367; 20140099557; 20140220450; 20140242445; 20140302403; 20140370388; 20150111105; 20150132650; 20150236342; 20150236349; 20150263382; 20150303474; 20150303474; 20150311565; 20150364753; 20160028114; 20160096334; 20160111720; and 20160164152, each of which is expressly incorporated herein by reference in its entirety.

See also:

Berrah, Fadila, et al. “The vanadium monophosphates AVOPO₄: Synthesis of a second form β-KVOPO₄ and structural relationships in the series.” Solid state sciences 3.4 (2001): 477-482.

Zima, Vitězslav, et al. “Ion-exchange properties of alkali-metal redox-intercalated vanadyl phosphate.” Journal of Solid State Chemistry 163.1 (2002): 281-285.

Lii, Kwang-Hwa, and Wei-Chuan Liu. “RbVOPO₄ and CsVOPO₄, Two Vanadyl (IV) Orthophosphates with an Intersecting Tunnel Structure and Discrete VO₅ Pyramids.” Journal of Solid State Chemistry 103.1 (1993): 38-44.

Yakubovich, 0. V., 0. V. Karimova, and 0. K. Mel'nikov. “The mixed anionic framework in the structure of Na₂{MnF [PO_{4]}.”} Acta Crystallographica Section C: Crystal Structure Communications 53.4 (1997): 395-397.

Schindler, M., F. C. Hawthorne, and W. H. Baur. “Crystal chemical aspects of vanadium: polyhedral geometries, characteristic bond valences, and polymerization of (VO n) polyhedra.” Chemistry of Materials 12.5 (2000): 1248-1259.

Panin, Rodion V., et al. “Crystal Structure, Polymorphism, and Properties of the New Vanadyl Phosphate Na₄VO (PO₄)₂.” Chemistry of materials 16.6 (2004): 1048-1055.

Belkhiri, Sabrina, Djillali Mezaoui, and Thierry Roisnel. “The Structure Determination Of A New Mixed Mono-Arsenate K₂V₂O₂ (AsO₄)₂.” 3ème Conférence Internationale sur le Soudage, le CND et l'Industrie des Matériaux etAlliages (IC-WNDT-MI'12). Centre de Recherche Scientifique et Technique en Soudage et Contr6le (CSC), 2012.

Glasser, Leslie, and C. Richard A. Catlow. “Modelling phase changes in the potassium titanyl phosphate system.” Journal of Materials Chemistry 7.12 (1997): 2537-2542.

Fedotov, Stanislav S., et al. “AVPO₄F (A=Li, K): A 4 V Cathode Material for High-Power Rechargeable Batteries.” Chemistry of Materials 28.2 (2016): 411-415.

Belkhiri, Sabrina, Djillali Mezaoui, and Thierry Roisnel. “K₂V20₂ (AsO₄) 2.” Acta Crystallographica Section E: Structure Reports Online 68.7 (2012): i54-i54.

Yakubovich, 0. V., V. V. Kireev, and 0. K. Mel'nikov. “Refinement of crystal structure of a Ge-analogue of natisite Na₂ {TiGeO₄} and prediction of new phases with anionic {MTO₅}radicals.” Crystallography Reports 45.4 (2000): 578-584.

Boudin, S., et al. “Review on vanadium phosphates with mono and divalent metallic cations: syntheses, structural relationships and classification, properties.” International Journal of Inorganic Materials 2.6 (2000): 561-579.

The electrolyte useful for the battery is one which does not chemically react with the anode or with the cathode during storage, and permits the migration of ions to intercalate the cathode-active material and vice-versa (during the discharge and charging cycles, respectively). The electrolyte may be present in a pure state (in the form of a solid, fused solid or liquid) or it may be conveniently dissolved in a suitable solvent. As a general rule, the electrolyte material should consist of a compound of the same species as that which is selected for the anode-active material. Thus, useful electrolytes may be conveniently represented by the general formula LY wherein L is a cationic moiety selected from the same materials useful as the anode-active material and Y is an anionic moiety or moieties such as halides, sulfates, nitrates, beta-aluminas, phosphofluorides, perchlorates and rubidium halide. The electrolyte may be present in a pure state in the form of a solid, fused solid (i.e., molten salt) or liquid or it may be conveniently dissolved in a suitable solvent which does not generally hydrolyze or degrade under conditions within the battery. Such electrolyes include ketones, esters, ethers, organic carbonates (such as propylene carbonate), organic lactones, organic nitriles, nitrohydrocarbons, organic sulfoxides, etc. and mixtures thereof. Where the solvent is utilized, the electrolyte salt may be present in a concentration determined by the desired solution conductivity, solubility and chemical reactivity.

The electrolyte may include additives to reduce flammability, such as phosphazenes, e.g., cyclic phosphazenes.

During initial cycling, a solid electrolyte interphase layer (SEI layer) forms in an electrolyte battery, representing insoluble breakdown products of the electrolyte in combination with other battery components, such as electrode material. The SEI layer serves to protect the electrolyte from further free radical reactions during overvoltage periods, e.g., during charging.

### SUMMARY OF THE INVENTION

The present technology provides a vanadyl phosphates KVOPO₄ cathode which has achieved multi-electron storage as sodium ion battery cathode.

Vanadyl phosphates in general, including potassium vanadyl phosphate KVOPO₄ have low intrinsic conductivity. A high efficiency battery cathode should have low electrical resistance. To overcome the conductivity problem, the cathode material is preferably nanosized, and coated with particles of a conductive material, such as carbon particles.

The potassium vanadyl phosphate (KVOPO₄) cathode material is preferably used in sodium ion batteries. This cathode utilizes the two redox couples of vanadium cation (i.e., V⁵⁺/V⁴⁺, V⁴⁺/V³⁺) to permit more than one sodium ion to be stored in the unit structure per vanadium ion. The involvement of the multiple redox processes of vanadium is reflected by the well separated high voltage plateau region at ˜3.8 V and low voltage plateau region at ˜2V.

The two-electron redox property of vanadium results in a theoretical capacity of 266 mAh/g. In practical, maximum 181 mAh/g discharge capacity was obtained within the voltage region of 1.3-4.5 V vs. Na/Na⁺, which is 68% of the theoretical value. 90% of the maximum capacity can be maintained over 28 repeated charge/discharge cycles. Using a combination of ex situ X-ray diffraction (XRD) measurement and galvanostatic intermittent titration (GITT) test. A Slight peak shift of the XRD peaks at different states of reaction and the continuous sloppy change in voltage in GITT curve indicated that the KVOPO₄ cathode probably undergoes a one-phase solid solution mechanism during charge/discharge.

The electrode material is not limited to use in batteries, or as a cathode, or for use in sodium ion electrolyte systems. The KVOPO₄ may be used as an electrode for a device having any alkali metal, including for Li, Na, K, Cs, Rb, as well as C, Al, Sn, Si, Ge, and any combinations thereof.

The KVOPO₄ may be used as a cathode material in combination with silicon-containing or silicon-rich (e.g., substituting for graphite) anodes in a sodium-ion, lithium-ion, or other metal ion battery systems. Alternatively, the potassium may be removed prior to use, leaving the large tunnels in the VOPO₄ material.

In addition to VOPO₄ material, the cathode may further contain any cathode material suitable for sodium-ion insertion and release. Suitable auxiliary materials may include phosphate-based materials such as FePO₄, VPO₄F, V₂(PO₄)₂F₃, FePO₄F, and V₂(PO₄)₃; oxides such as CoO₂, orthorhombic MnO₂, layered iron oxides FeO₂, chromium oxide CrO₂, layered Ni_{0.5}Mn_{0.5}O₂, and V₆O₁₅ nanorods; layer sulfides such as TiS₂; perovskite transition metal fluorides such as FeF₃; Na⁺ superionic conductor (NASICON)-related compounds, or a mixture thereof. These materials may be sodium and/or potassium complexes, either as provided within the battery as manufactured, or as may result during operation.

A new material (i.e., KVOPO₄) was synthesized and tested as a cathode material for sodium ion batteries. It is a multi-electron cathode which can store more than one sodium ion during a single charge/discharge process. The multi-electron feature makes KVOPO₄ a high energy density sodium ion battery cathode, which could be applied in electrical vehicles, portable electronics, grid applications, etc.

The application of the sodium ion battery has been greatly limited by its intrinsic low energy density. The cathode side is typically the bottleneck of the energy density improvement in sodium ion batteries. Basically, the normal cathodes can store a maximum of one sodium ion (i.e., one electron charge) per molecule, which limits capacity. The present technology makes it possible for the cathode material to store more than one sodium ion in each single charge/discharge process, which can greatly increase the energy density of sodium ion battery devices. The sodium ion battery has great potential to be an alternative of lithium ion battery due to the more abundant thus much cheaper sodium. As the key component of sodium battery, the KVOPO₄ cathode has extremely broad market prospects.

The KVOPO₄ phase was prepared through a solid state reaction method. The reagents utilized were K₂CO₃, NH₄H₂PO₄ and NH₄VO₃ with molar ratio of 0.5:1:1. The reagent powers were firstly mixed by 4 h planetary ball milling. The obtained precursor was pressed at pressure of 3 tons for 2 minutes, in order to get pellets for the following solid state reaction. The reaction temperature was set as 600° C., 700° C. and 800° C. The heating rate is 5° C./min. The soaking (dwell/holding) time at the reaction temperatures is 10 hrs. After reaction, the furnace was cooled down to room temperature naturally. An argon atmosphere was utilized during both the heating and soaking processes. The as prepared KVOPO₄ powers was also ball milled together with super P (KVOPO₄:C=7:2) in order to achieve particle-size reduction and carbon coating. The ball milling time parameters were 0.2 h, 0.4 h, 0.6 h. A slurry of 90% KVOPO₄/C composite, and 10% PVDF binder dissolved in N-methylpyrrolidone was coated on aluminum foil and then dried at 110° C. overnight to obtain the electrodes. The typical mass loading of the electrodes was 2 mgcm⁻¹. An electrolyte of 1M NaPF₆ in propylene carbonate (PC) and polyethene-based separator were utilized for Na-ion battery tests.

This new cathode material could be used in sodium ion batteries for reversible sodium storage. The battery may be fabricated in any desired form factor, including cylindrical cells, prismatic cells, button cells, etc. A particularly preferred form factor are large-scale cells for grid energy storage, industrial and/or commercial scale systems, large vehicles, and the like. These batteries may also be used for portable electronics power sources (e.g., cellphone, laptop, etc.), electric vehicles (e.g., hybrid car, bus, etc.), and stationary facilities.

An advantage of vanadyl phosphate materials intrinsically formed with potassium, is that they preserve a large cell size. KVOPO₄ thus has an advantage over the other VOPO₄ materials, in that the larger cell volume allows for the more rapid diffusion of sodium into and out of the structure. Further, KVOPO₄ has advantages over competitive cathodes, such as other ceramic cathode materials, layered transition metal oxides, tunnel-type transition metal oxides, olivine phosphates, pyrophosphates, mixed polyanions, NASICON materials, fluorophosphates, fluorides, etc., in that the present technology provides a higher energy density (both gravimetric and volumetric) and better safety, which are the most important two factors for today's Li/Na ion battery products.

KVOPO₄ has a relatively large voltage gap between the two voltage plateau regions, and the second voltage region (i.e., the 2nd sodium ion) is relatively low (i.e., 1.5-2 V vs. Na/Na⁺). These two issues could be overcome, for example, by reducing the particle size of the material and introducing more electrical conductive secondary carbon phase. The voltage gap between voltage plateaus could be reduced by the vanadium substitution method. An advanced voltage converter could be used to normalize output voltage, and thus provide high tolerance of powered devices for the change in voltage over the battery cycle.

It is therefore an object to provide an electrode comprising KVOPO₄ as an active ingredient, wherein the electrode is capable of electrochemical insertion and release of a metal ion selected from the group consisting of at least one of alkali and alkaline earth metal ions.

It is also an object to provide an electrode comprising VOPO₄ as an active ingredient, which has a volume greater than 90 Å3 per VOPO₄, wherein the electrode is capable of electrochemical insertion and release of a metal ion selected from the group consisting of at least one of alkali and alkaline earth metal ions.

It is a further object to provide a reversible battery having a cathode comprising KVOPO₄ or VOPO₄, which has a volume greater than 90 Å3 per VOPO₄, wherein the cathode further comprises a current collector.

Another object provides a battery comprising: an anode; a cathode; and an electrolyte comprising sodium ions; wherein the cathode comprises a current collector and an active material comprising KVOPO₄ or a VOPO₄, which has a volume greater than 90 Å³ per VOPO₄.

The metal ions may be, for example, sodium ions, or other alkaline (Li, K, Rb, Cs) or alkaline earth (Be, Mg, Ca, Sr, Ba).

The electrode may serve as a cathode material within a sodium ion rechargeable battery.

The electrode may be provided in combination with a sodium donor anode and/or a sodium ion transport electrolyte.

The electrode may further comprise an insoluble conductive additive, such as a conductive carbon additive, or elemental carbon additive.

The KVOPO₄ may be formed by a solid phase synthesis process from a powdered mixture of ammonium metavanadate, ammonium phosphate monobasic, and potassium carbonate heated.

The mixture may be heated at a temperature of between 600-800° C. The solid phase synthesized KVOPO₄ may be mixed with carbon black and milled.

The electrode may comprise KVOPO₄ particles and conductive additive particles, having a secondary particle size of around 2 μm, and a primary particle size of around 200 nm.

A binder may be provided, such as one or more of poly(vinylidene fluoride), polytetrafluoroethylene (PTFE), a styrene butadiene rubber (SBR), and a polyimide.

The electrode may be provided in combination with a sodium-containing anode, and a sodium transport electrolyte, to form a battery having an open circuit voltage comprising 3 volts, i.e., the range of the open circuit voltage includes 3V.

The battery may have a capacity of at least C=133 mAhg⁻¹.

A discharge voltage curve of the battery may comprise two major plateau regions. A higher voltage plateau region has a voltage comprising about 3.8 V, and a lower voltage plateau region has a voltage comprising about 2 V.

The electrode may be used in conjunction with an electrolyte comprising at least one of an organic nitrile, an organic ether, and an organic carbonate solvent. Such an electrolyte may be suitable for use in a sodium ion battery. The electrolyte preferably comprises an organic carbonate solvent, e.g., at least one of ethylene carbonate, diethyl carbonate, and propylene carbonate.

It is another object to provide a method of forming an electrode, comprising: milling a mixture of ammonium metavanadate, ammonium phosphate monobasic, and potassium carbonate; heating the milled mixture to a reaction temperature, and holding the reaction temperature until a solid phase synthesis of KVOPO₄ occurs; milling the KVOPO₄ together with conductive particles to form a conductive mixture of fine particles; and adding binder material to form a conductive cathode material. The reaction temperature is, for example, between 600° C. and 800° C. for about 10 hours.

### BRIEF DESCRIPTION OF THE DRAWINGS

FIG. 1A shows an X-ray diffraction (XRD) pattern and Rietveld refinement of as-synthesized KVOPO₄.

FIG. 1B shows a scanning electron microscope (SEM) image of ball milled KVOPO₄ cathode material.

FIG. 2A shows the two intersecting six side tunnels along an a axis and a b axis, representing tunnel 1: Along the a axis, the tunnel is formed of four VO₆ octahedra (1,3,4,6) and two PO₄ tetrahedra (2,5).

FIG. 2B shows the [VO₃]_{∞} chain, representing tunnel 2: Along the b axis, the tunnel is formed of three VO₆ octahedra (1,3,5) and three PO₄ tetrahedra (2,4,6).

FIG. 2C shows the coordinates of vanadium cation.

FIG. 2D shows two types of VO₆ tetrahedra.

FIG. 3A shows galvanostatic charge/discharge profiles of KVOPO₄ cathode.

FIG. 3B shows specific discharge capacities of KVOPO₄ cathode as a function of cycle number.

FIG. 4A shows GITT capacity-voltage profiles of the KVOPO₄ cathode.

FIG. 4B shows GITT time-voltage profiles of the KVOPO₄ cathode.

FIGS. 5A-5D show ex situ XRD patterns at different states of charge/discharge.

FIGS. 6A-6D show structural illustrations of the monoclinic NaVOPO₄ polymorph consisting of VO₆ octahedra (blue), PO₄ tetrahedra (dark green) and Na atoms (white).

FIGS. 7A-7D show (7 Å) CV profiles (scan rate at 0.1 mV s−1); (7B) charge-discharge curves (current density of 5 mA g−1) at room temperature of (b) non-ball-milled NaVOPO₄; (7C) ball-milled NaVOPO₄ and (7D) cycling performance of ball-milled NaVOPO₄ at a current density of 10 mA g⁻¹.

### DETAILED DESCRIPTION OF THE PREFERRED EMBODIMENTS

### Example 1

### Synthesis of KVOPO₄ Cathode Material

1.17 g of ammonium metavanadate, 1.15 g of ammonium phosphate monobasic and 0.69 g of potassium carbonate were uniformly mixed by 4 hours planetary ball milling in the presence of 20 mL acetone. The obtained powders were completely dried in air at room temperature, which were used as precursor for the following solid state reaction, conducted under an argon atmosphere.

The dry powders were pressed into pellets at a pressure of 3 tons for 2 mins, and each pellet has a typical weight of 200 mg. Five such pellets were used for one batch solid state synthesis. The pellets were heated to 700° C. with a heating rate of 5° C. per min, maintained at 700° C. for 10 hours, and then cooled down to room temperature at cooling rate of 5° C. per min.

Reddish brown powders were obtained after the solid state reaction process. The typical yield is 700 mg for each batch.

400 mg of KVOPO₄ reddish brown powder and 114 mg of carbon black were mixed using a mortar and pestle (i.e., a weight ratio of 7:2). The mixture was high energy ball milled for 12 mins. (This time may be extended to, e.g., 36 min. as may be desired). Black color powders were obtained after the ball milling. The typical yield is 450 mg for each batch.

### Material Characterization

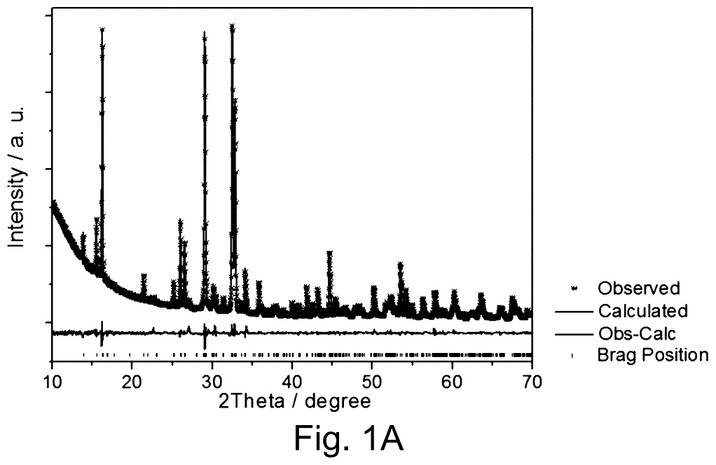

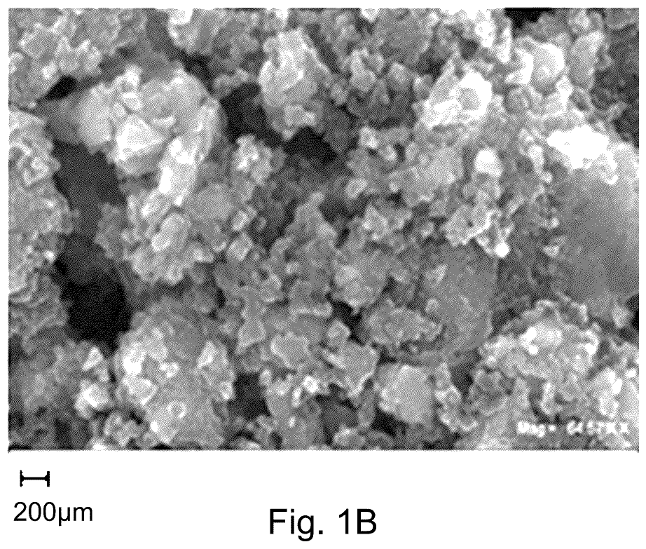

The X-ray diffraction data was collected by a Scintag XDS2000 diffractometer equipped with Cu Kα sealed tube. XRD data Rietveld refinement was performed using the GSAS/EXPGUI package. The SEM image was collected by Zeiss Supra-55 field emission scanning electron microscope, and is shown in FIG. 1 and Table 2.

TABLE 2
XRD powder diffraction and Rietveld refinement
results for KVOPO₄ powder sample.

| Symmetry | Orthorhombic |
|---|---|
| Space group | Pna2₁ |
| Lattice parameters | a = 12.7671(7) Å, b = 6.3726(2) Å, |
| | c = 10.5163(0) Å, |
| | V = 855.6(1) Å³ |
| R_{wp} (%) | 4.82 |
| x² | 3.423 |

Basically, the compound was completely indexed with space group of Pna2₁ with orthorhombic symmetry. The cell dimension parameters (a=12.7671(7) Å, b=6.3726(2) Å, c=10.5163(0) Å, V═855.6(1) Å³) is much larger comparing to the lithium and sodium counterparts. This should be due to the much larger size of potassium ions (2.76 vs. 2.04 Å). The as-prepared KVOPO₄ power was ball milled together with super P (weight ratio=7:2) in order to decrease the particle size of KVOPO₄ and wrap the smaller particles with amorphous carbons. FIG. 1B displays an SEM image of the ball milled material. The secondary particle size is around 2 μm, and the primary particle size is around 200 nm.

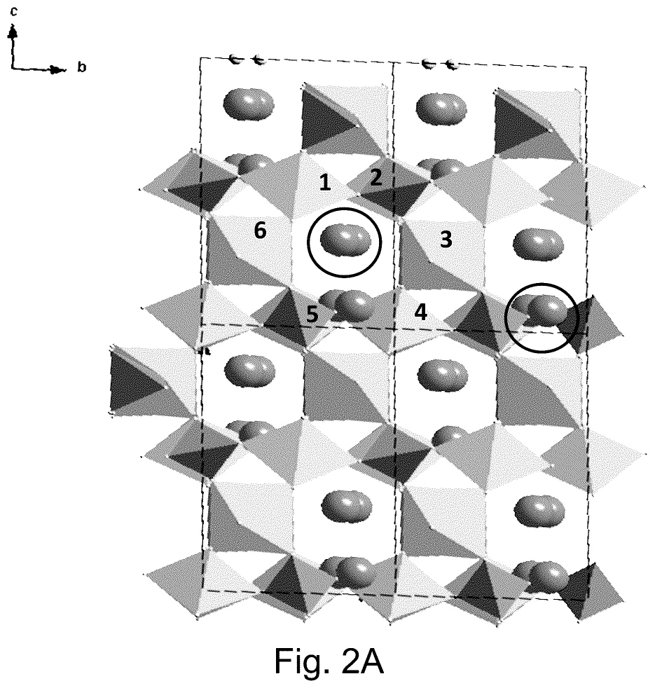

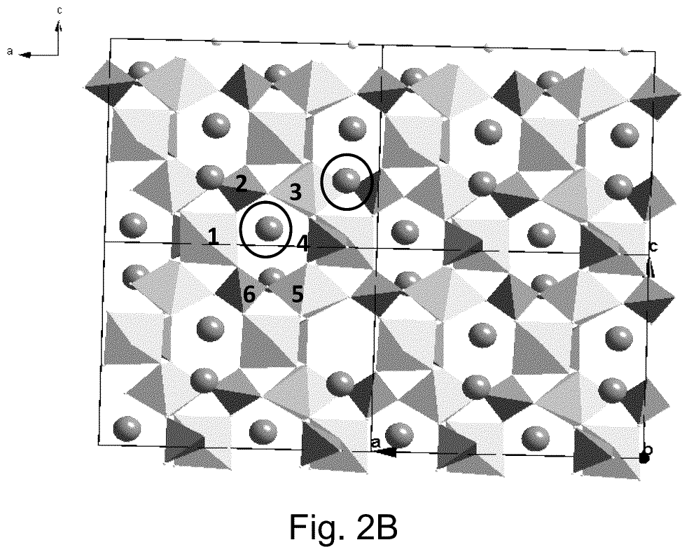

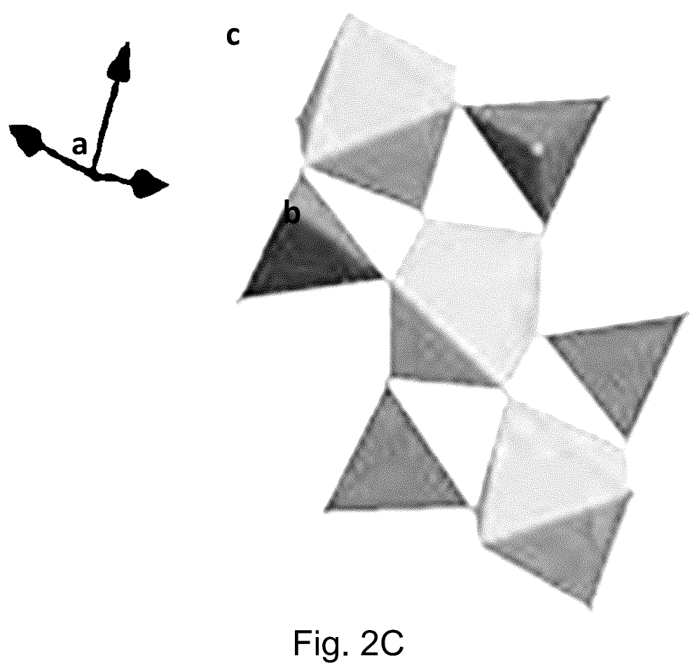

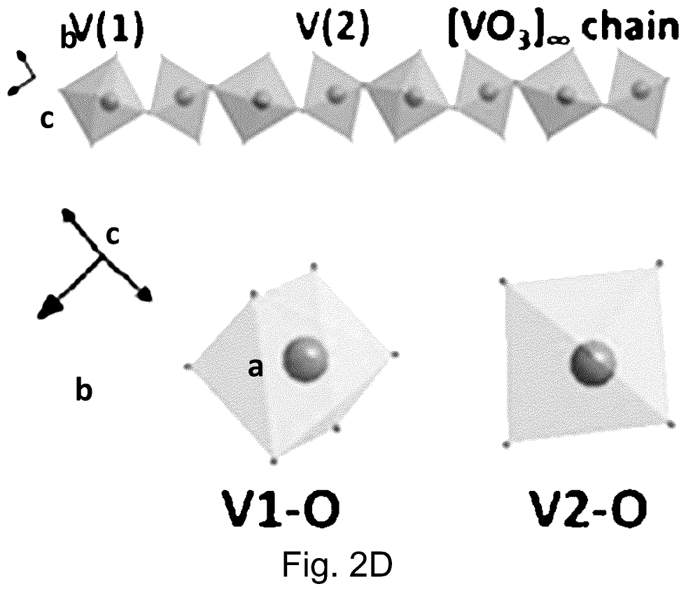

The remaining VOPO₄ framework of the KVOPO₄ compound is assembled by corner-sharing VO₆ octahedra and PO₄ tetrahedra. The whole VOPO₄ structure can provide two intersecting six side tunnels for the following Na⁺ intercalation. FIG. 2 shows the two types of tunnels along the a and b axis respectively. The tunnel along the a axis is formed of rings of two PO₄ tetrahedra (marked as 2, 5) and four VO₆ octahedra (marked as 1, 3, 4, 6). The tunnel along the b axis is formed of rings of three PO₄ tetrahedra (marked as 2, 4, 6) and three VO₆ octahedra (marked as 1, 3, 5). Due to the intersection of the two tunnels, the effective diffusion pathways for Na ions could be two or even three dimensional instead of one dimensional, which is more benefitting for the kinetics of cathode.

TABLE 3
Atomic coordinates for KVOPO₄.

| | X | y | z |
|---|---|---|---|
| V(1) | 0.123949 | −0.006684 | 0.255227 |
| V(2) | 0.247143 | 0.272448 | 0.507111 |
| P(1) | 0.182754 | 0.507027 | 0.235075 |
| P(2) | −0.007772 | 0.178751 | 0.493906 |
| K(1) | 0.382056 | 0.772807 | 0.435412 |
| K(2) | 0.397591 | 0.203688 | 0.162091 |
| O(1) | 0.105733 | 0.304952 | 0.196314 |
| O(2) | 0.107539 | −0.309492 | 0.269465 |
| O(3) | −0.002507 | 0.015824 | 0.369038 |
| O(4) | 0.015493 | −0.034588 | 0.100065 |
| O(5) | 0.232475 | −0.036421 | 0.109097 |
| O(6) | 0.219554 | 0.021262 | 0.355514 |
| O(7) | 0.397020 | 0.200980 | 0.458928 |
| O(8) | 0.249809 | 0.018958 | 0.629969 |
| O(9) | 0.086298 | 0.304742 | 0.502290 |
| O(10) | 0.260082 | 0.470928 | 0.341831 |

TABLE 4
V—O bonds distance (Å) for KVOPO₄.

| | Bond | CN | R (Å) |
|---|---|---|---|
| V(1) | V—Oₛₕₒᵣₜ | 1 | 1.697(11) |
| | V—O_{eq} | 4 | 1.833(15)-2.187(10) |
| | V—O_{long} | 1 | 2.370(11) |
| V(2) | V—Oₛₕₒᵣₜ | 1 | 1.881(12) |
| | V—O_{eq} | 4 | 1.889(13)-2.134(10) |
| | V—O_{long} | 1 | 2.313(13) |

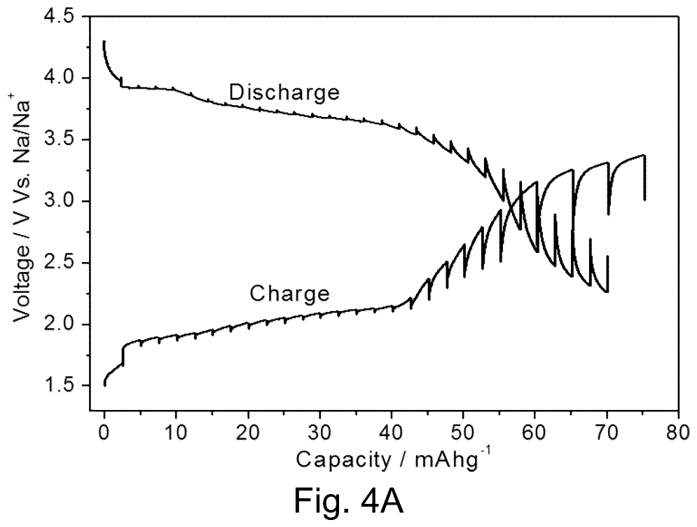

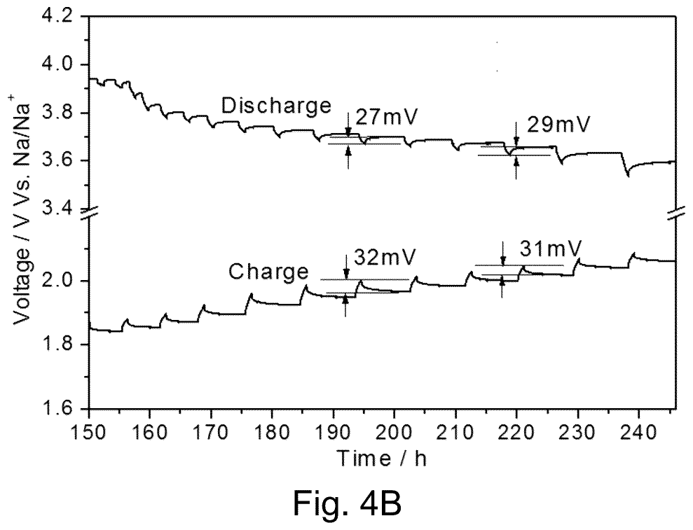

The atomic coordinate values were listed in Table 3, there are two different potassium, two different vanadium (V(1), V(2)) and two different phosphorus. As shown in FIG. 4a, V(1) and V(2) alternate with each other forming the infinite [VO3]_{∞} chain. The potassium ions sitting in the two kinds of tunnels also differ from each other in term of local coordination environment. In the VO₆ octahedra, the six oxygen atoms link with the central vanadium atom by one short, one long and four equatorial V-O bonds. The bond length for V(1) and V(2) were listed in Table 4. It is worthwhile to mention that the different coordinates of vanadium ions could provide different local environments around the Na sites.

### Electrochemical Tests

200 mg of ball milled KVOPO₄/Carbon composite was mixed with 22.2 mg poly(vinylidene fluoride) (PVDF) together with 500 μL N-Methyl-2-pyrrolidone to form a uniform viscous slurry. The slurry was casted on to aluminum foil using doctor blade. After drying, circular electrodes with area of 1.2 cm² were punched from the foil with 2-4 mg of active material on each circular electrode. The electrode was immersed in a 1 M solution of sodium hexafluorophosphate in propylene carbonate. A sheet of sodium, 1.24 cm in diameter, served as the anode. 30 μL liquid electrolyte was used in each half cell (i.e., 2325-type coin cells). All manipulations were performed in a helium environment.

The initial open circuit voltage of the cell was around 3 volts. The cells were tested using a VMP2 mutichannel potentiostat (Biologic).

The electrochemical performance of KVOPO₄ as cathode was tested in a half cell configuration with sodium metal as both counter and reference electrode. The pristine electrode was first galvanostatically charged to a high cut-off voltage of 4.7 V vs. Na/Na⁺ in order to furthest remove the potassium ion from the structure and oxidize V⁴⁺ to V⁵⁺. The current density used was C/50 (C=133 mAhg⁻¹). According to the charge profile, there should be side reaction of the electrolyte involved in the very high voltage region above 4.5 V. Since normal propylene carbonate electrolyte was used here, this side reaction above 4.8 V vs. Li/Li⁺ is expected and acceptable. The subsequent discharge process should insert sodium into the electrode.

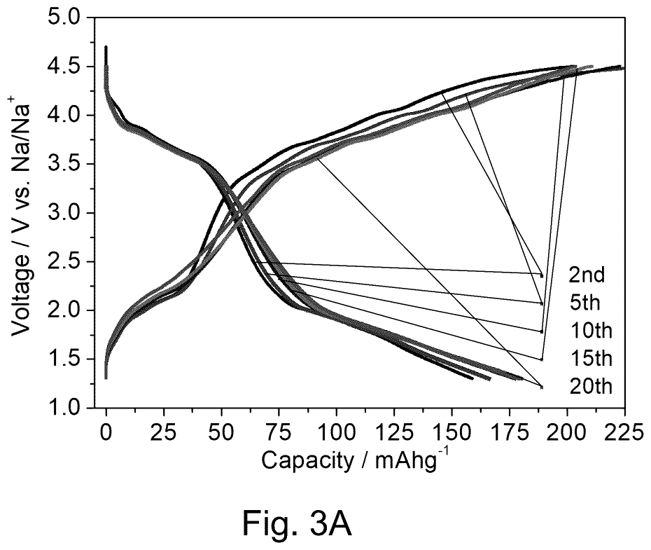

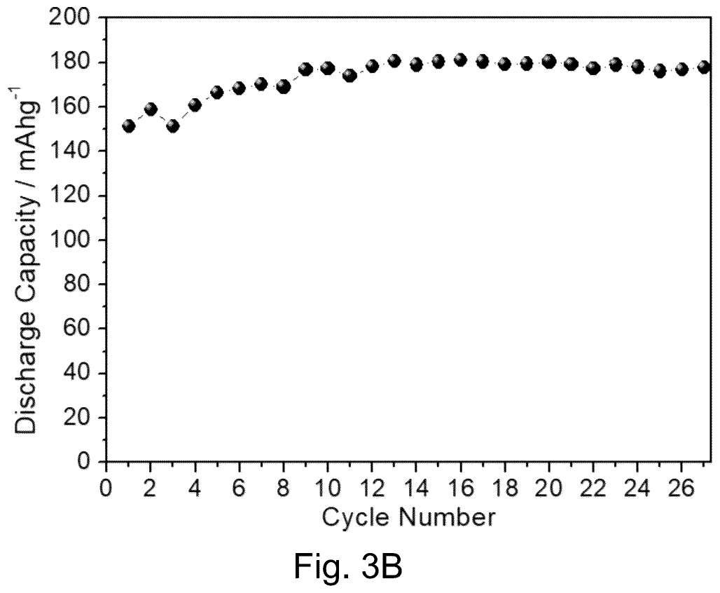

As shown in FIG. 3A, discharge capacity of 158 mAhg⁻¹ was obtained in the first discharge (i.e., 2^{nd} cycle) at current density of C/50. After discharging the electrode was charged back to cut-off voltage of 4.5 V vs. Na/Na⁺ to remove sodium again. In the following cycles, the electrode swung between 1.3 and 4.5 V vs. Na/Na⁺. Apparently, the electrode exhibited two major plateau regions within the voltage window. The higher voltage plateau region was centered at ca. 3.8 V and the low voltage plateau region was centered at ca. 2 V.

From a thermodynamic point of view, the higher voltage region should be related to the V⁵⁺/V⁴⁺ redox couple and the lower voltage region should be related to the V⁴⁺/V³⁺ redox couple. Based on the specific discharge capacity of 158 mAhg⁻¹ (i.e., exceeding the theoretical value derived from one Na), the KVOPO₄ should be a two-electron cathode which should have theoretical capacity of 266 mAhg⁻¹. This multi-electron characteristic is rarely observed for sodium ion cathode, which is greatly helpful for solving the intrinsic low energy issue of sodium-based systems.

There is hysteresis observed in the charge/discharge profile, which is most likely due to the potential coexistence of the two redox couples. Both the high and low voltage regions exhibited additional substructure, i.e., there are slope changes along the sloppy plateau regions. These sub-plateaus indicated the multiple sodium storage sites existing in the structure and there is no preference for sodium ions to enter any specific site. This sodium site multiplicity is closely related to the different local coordinate environments of vanadium, which has been detailed discussed in the crystal structure section.

As shown in FIGS. 3A and 3B, the KVOPO₄ cathode was reversible cycled over 25 cycles. The discharge capacity keeps increase during cycling with maximum value of 181 mAhg⁻¹, which is 68% of the theoretical capacity based on two sodium storage. The increasing discharge capacity indicated a continuously activation of the cathode, which mainly resulted from more potassium extraction from the structure. The sodium storage capability of KVOPO₄ could be further improved by more deeply removing potassium from the structure to empty more sodium intercalation sites.

The properties of various cathode materials for use in sodium ion batteries are shown in Table 5, in comparison to KVOPO₄.

TABLE 5
Properties of cathode materials.

| | | Layered | | Olivine | | | | |
|---|---|---|---|---|---|---|---|---|
| | | oxide | Tunnel | (e.g., Na | | NASICONS | Fluorophosphates | Fluorides |
| | | (e.g., | oxide (e.g., | Fe | Pyrophosphates (e.g., | (e.g., | (e.g., | (e.g., |
| KVOPO₄ | | NaMnO₂) | Na_{0.44}MnO₂) | Mn_{0.5}PO₄) | Na₂FeP₂O₇) | NaV(PO)) | NaVPO₄F) | FeF) |
| Capacity | 180 | ~185 | ~140 | ~93 | ~90 | ~140 | ~120 | ~125 |
| (mAhg⁻¹) | | | | | | | | |
| Energy | 442.5 | ~470 | ~400 | ~280 | ~300 | ~330 | ~400 | ~350 |
| density | | | | | | | | |
| (Whkg⁻¹) | | | | | | | | |
| Voltage | 1.5-4.3 | 2.0-3.8 | 2-3.8 | 2-4 | 2-4.5 | 1.2-3.5 | 3-4.5 | 1.5-4 |
| window | | | | | | | | |
| (V) | | | | | | | | |
| Safety | stable up to | stable up to | stable up to | stable up to | stable up to | stable up to | stable up to | stable up to |
| (thermal | 600° C. | ~300° C. | ~300° C. | ~600° C. | ~600° C. | ~450° C. | ~500° C. | ~320° C. |
| stability) | | | | | | | | |

| | |
|---|---|
| Materials | Depending on the element the specific cathode material contains. |
| costs | |
| Mfg | Largely depending on the synthesis strategy and elements contained for a specific |
| costs | cathode material. |

The reaction kinetics of KVOPO₄ cathode was investigated by GITT in FIGS. 4A and 4B. The electrode shows very small hysteresis during the charging in the low voltage region (i.e., V³⁺/V⁴⁺ transition) and discharging in the high voltage region (i.e., V⁵⁺/V⁴⁺, transition). According to the voltage versus time chart in FIG. 4B, the overpotential during these two processes is only˜2.8 mV during discharge and 32 mV during charge, respectively. The small polarization indicated the relatively fast kinetics of electrochemical reaction of the cathode. The overpotential has significantly increased when the electrode was charged into the high voltage region or discharged into the low voltage region, which is expected due to the higher energy barrier for the sodium ion bulk diffusion in the related voltage regions. If all the open circuit voltage point in the GITT curve was linked, the formed OCV curve is a sloping shape within the whole voltage region without any pronounced flat plateau. This sloping OCV curve indicated the solid solution behavior during the sodium ion intercalation/extraction.

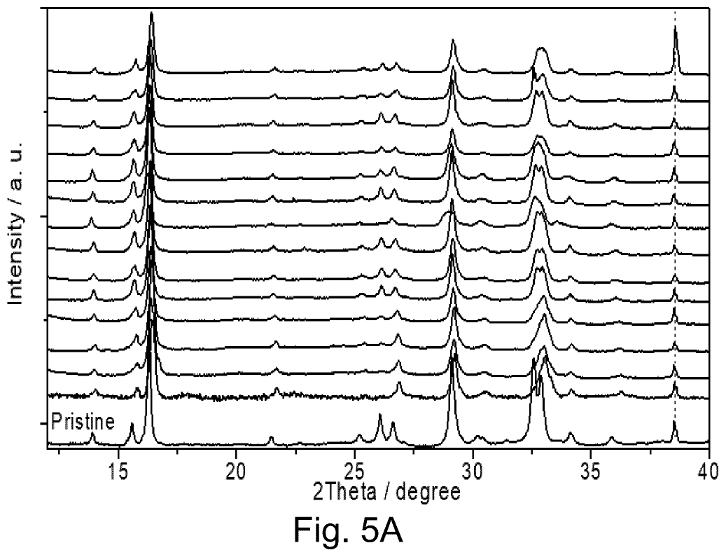

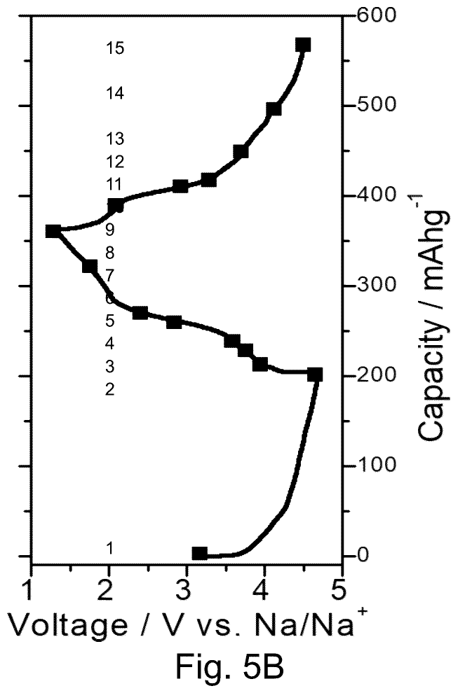

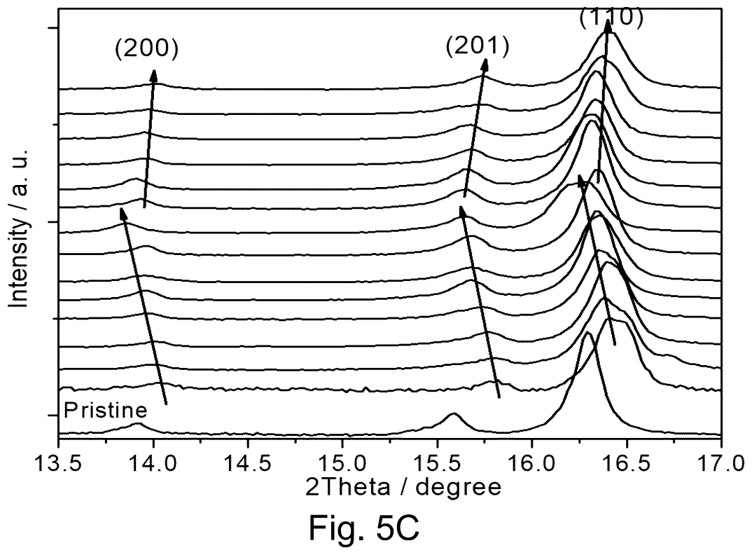

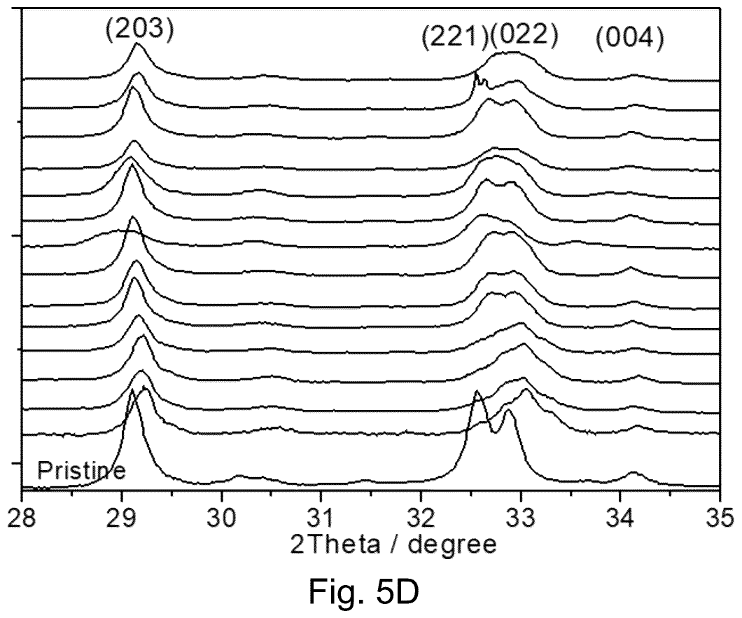

The crystallographic evolution of KVOPO₄ cathode during charge/discharge was investigated by ex situ XRD. The electrodes were galvanostatically sodiated/desodiated to different cut-off voltages at C/50 and then tested by XRD. The patterns were shown in FIGS. 5A-5D. For all the XRD patterns at different voltage states, there is no addition diffraction peaks observed. The absence of new peaks indicated the absence of additional new phase during the whole voltage window. As shown in the highlighted regions, some of the peak positions (e.g., (200), (201), (110)) displayed continuously shift in one direction during discharging and shifted back during charge. Some of the well-resolved peaks (e.g., (221), (022)) in the pristine material has merged into one broad peak during some states of charge/discharge, indicating they could shift towards different directions. These new peak absence and peaks shift are clear indications of a single-phase reaction mechanism of the electrochemical reaction. Otherwise, emergence and growth of second phase peaks would happen if a two-phase reaction involved.

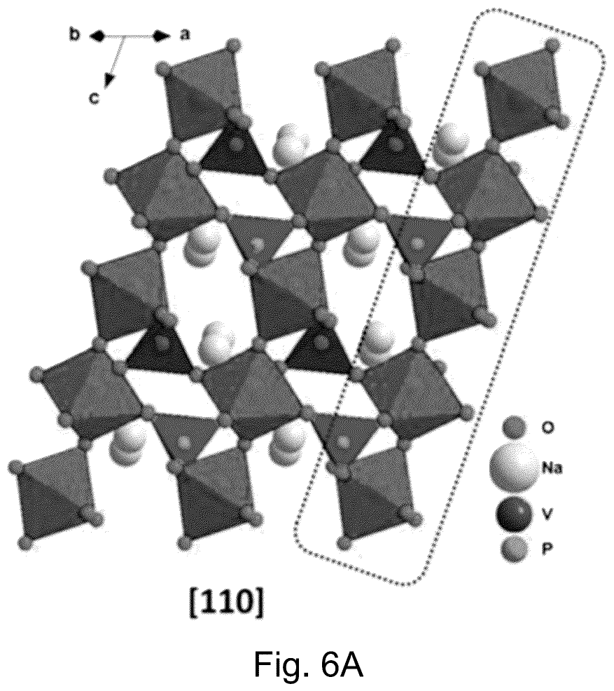

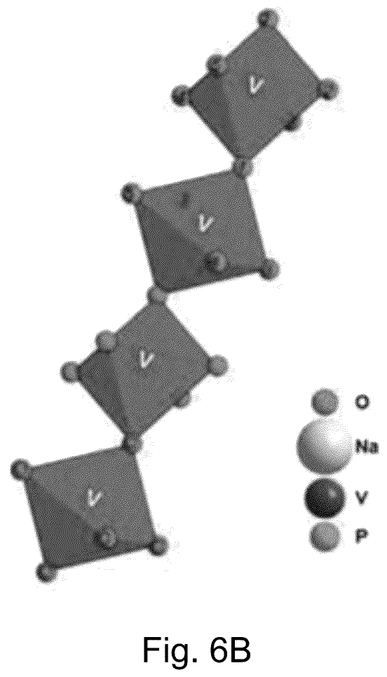

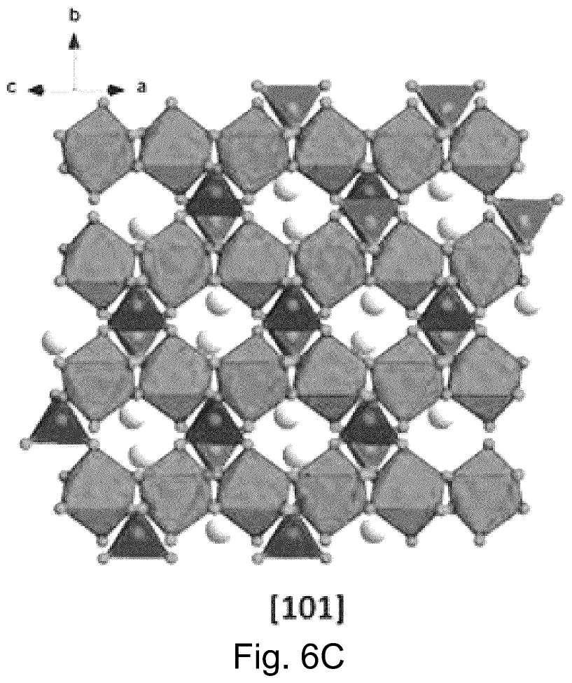

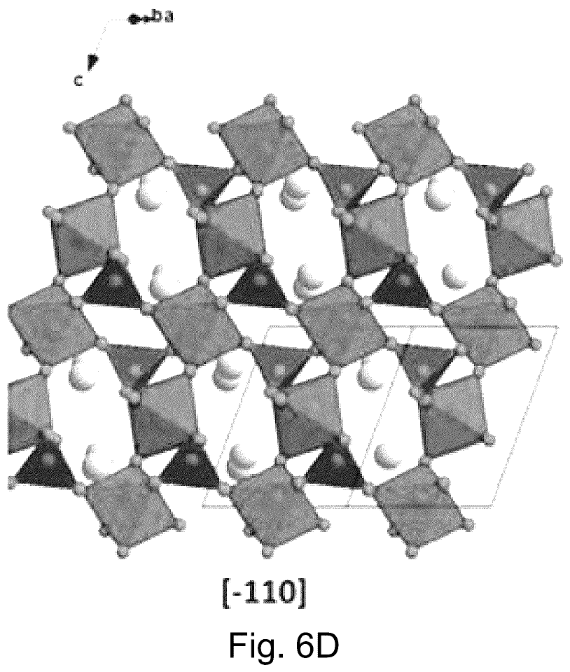

FIGS. 6A-6D show structural illustrations of the monoclinic NaVOPO₄ polymorph consisting of VO₆ octahedra (blue), PO₄ tetrahedra (dark green) and Na atoms (white). These are comparable to the structural illustrations shown in FIGS. 2A-2D for KVOPO₄.

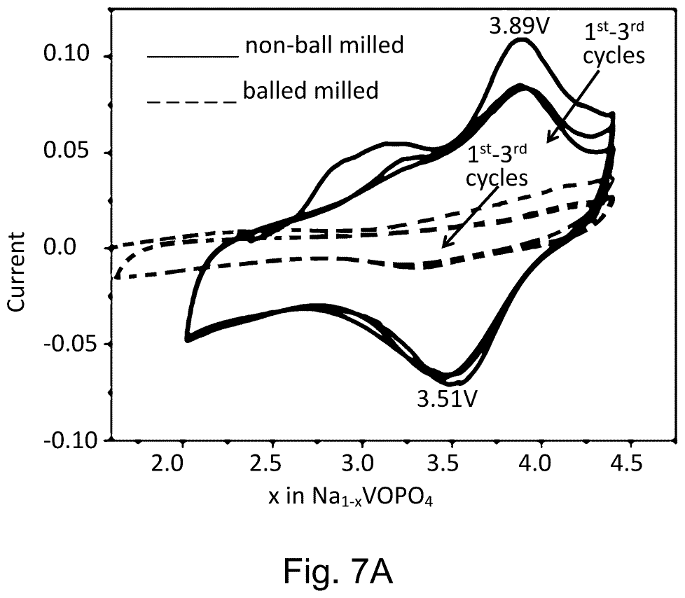

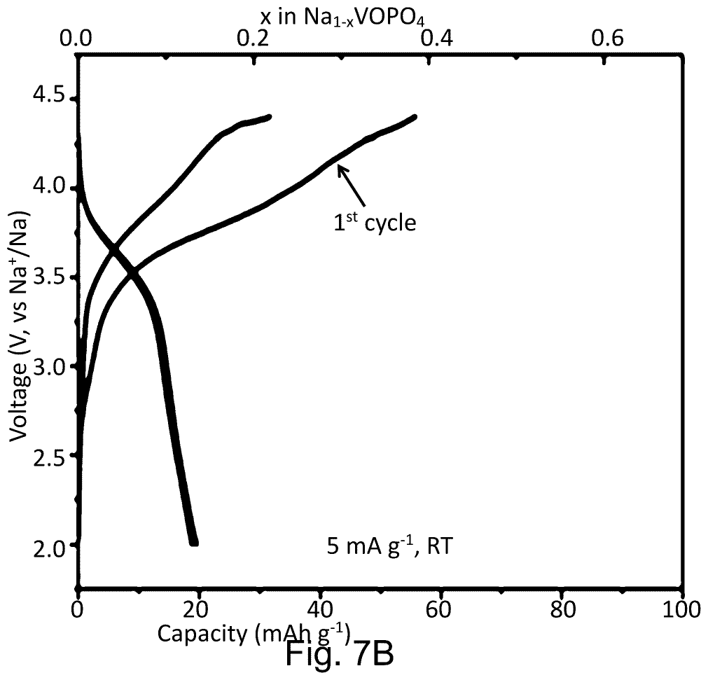

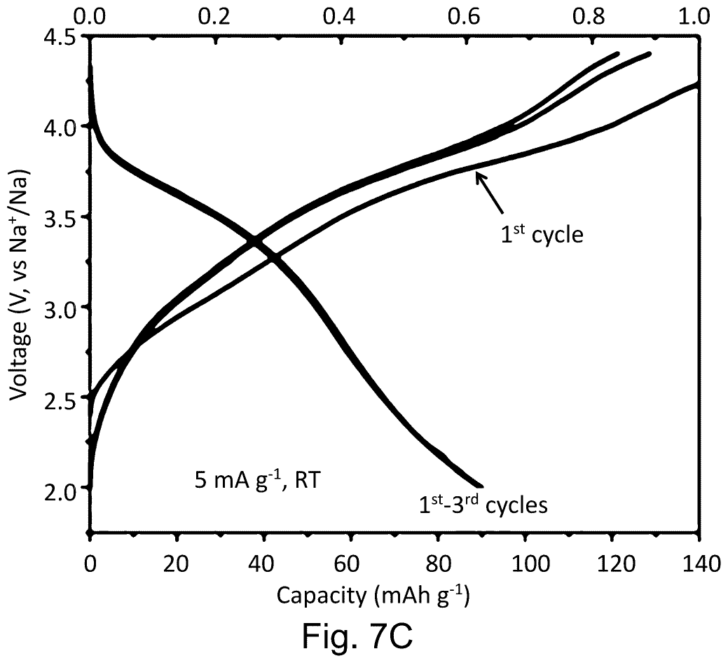

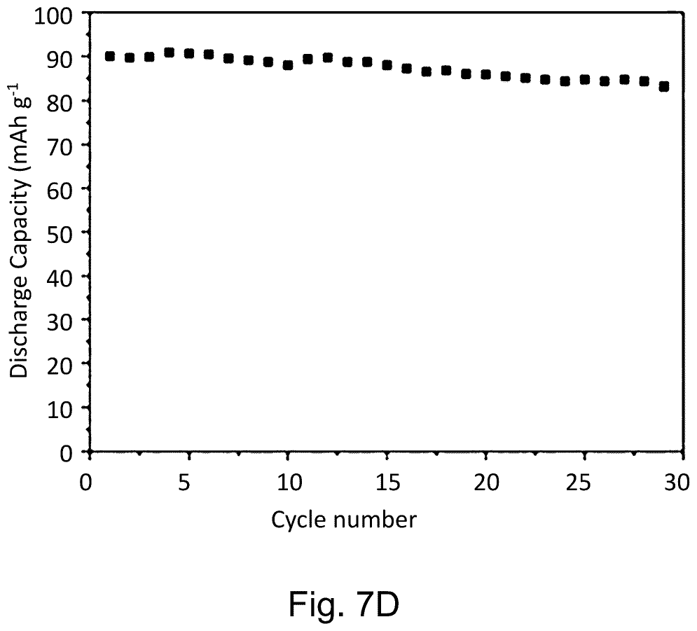

FIGS. 7A-7D show (7 Å) CV profiles (scan rate at 0.1 mV s−1); (7B) charge-discharge curves (current density of 5 mA g−1) at room temperature of (b) non-ball-milled NaVOPO₄; (7C) ball-milled NaVOPO₄ and (7D) cycling performance of ball-milled NaVOPO₄ at a current density of 10 mA g⁻¹. This shows the much lower capacity of the NaVOPO₄ as compared to the KVOPO₄ material according to the present invention.

Throughout this description all ranges described include all values and sub-ranges therein, unless otherwise specified. Additionally, the indefinite article “a” or “an” carries the meaning of “one or more” throughout the description, unless otherwise specified. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

What is claimed is:

1. A battery comprising:
a cathode comprising a VOPO₄ lattice having a crystalline structure having orthorhombic symmetry with space group Pna2₁;
a sodium ion donor anode; and
a sodium ion transport electrolyte.

2. The battery according to claim 1, wherein the electrolyte is non-aqueous.

3. The battery according to claim 1, wherein the cathode further comprises an insoluble conductive additive.

4. The battery according to claim 3, wherein the insoluble conductive additive comprises a conductive carbon additive.

5. The battery according to claim 1, wherein the VOPO₄ lattice is formed by a solid phase synthesis process from ammonium metavanadate, ammonium phosphate monobasic, and potassium carbonate to form solid phase synthesized KVOPO₄, followed by replacement of potassium ions with sodium ions to form NaVOPO₄.

6. The battery according to claim 5, wherein the solid phase synthesized KVOPO₄ is mixed with carbon black and milled, and then mixed with a binder, before the replacement of the potassium ions with sodium ions to form NaVOPO₄.

7. The battery according to claim 1, wherein the VOPO₄ lattice of the cathode comprises NaVOPO₄ particles having particle size of 200 nm and conductive additive particles having a particle size of 2 μm.

8. The battery according to claim 7, further comprising a poly(vinylidene fluoride) binder.

9. The battery according to claim 1, wherein the cathode has a capacity of at least C=133 mAhg⁻¹.

10. The battery according to claim 1, having a discharge voltage curve comprising two major plateau regions.

11. The battery according to claim 10, wherein the two major plateau regions comprise a first voltage plateau region of at least 3.8 V, and a second voltage plateau region of at least 2 V.

12. The battery according to claim 1, wherein the VOPO₄ lattice has a volume greater than 90 Å³ per VOPO₄.

13. A NaVOPO₄ electrode, comprising a VOPO₄ lattice,
the VOPO₄ lattice having a volume greater than 90 Å³ per VOPO₄; and
a portion of the VOPO₄ lattice having two sodium ions per VOPO₄.

14. The electrode according to claim 13, wherein the NaVOPO₄ has orthorhombic symmetry has space group Pna2₁, formed by a replacement of at least a portion of potassium in solid phase synthesized KVOPO₄ with sodium.

15. The electrode according to claim 14, wherein the KVOPO₄ is milled together with carbon particles, before the replacement of at least a portion of potassium with sodium.

16. The electrode according to claim 13, in combination with a sodium battery anode and a non-aqueous sodium ion transport electrolyte to form a sodium ion battery, the sodium ion battery having a capacity of at least C=133 mAhg⁻¹, and a discharge voltage curve comprising a first voltage plateau region comprising 3.8 V, and a second voltage plateau region comprising 2 V.

17. An electrode, comprising a VOPO₄ lattice a volume greater than 90 Å³ per VOPO₄ and at least a portion of the lattice having a sodium exchange capacity of two sodium ions per VOPO₄, formed by solid phase synthesis of KVOPO₄ followed by replacement of potassium ions with sodium ions to form NaVOPO₄.

18. The electrode of claim 17, wherein the KVOPO₄ is formed by heating a milled mixture of ammonium metavanadate, ammonium phosphate monobasic, and potassium carbonate.

19. The electrode according to claim 17, further comprising carbon conductive particles and a binder material selected from one or more of the group consisting of a poly (vinylidene fluoride), a polytetrafluoroethylene, a styrene butadiene rubber, and a polyimide.

20. The electrode according to claim 17, wherein the NaVOPO₄ has a lattice having a crystalline structure having orthorhombic symmetry with space group Pna2₁.
